(19) United States
(12) Patent Application Publication
(10) Pub. No.: US 2024/0182718 A1
(43) Pub. Date: Jun. 6, 2024

(54) PETROLEUM ASPHALT CEMENT COMPOSITION FROM URBAN SOLID WASTE AND PROCESS FOR OBTAINING SAID PETROLEUM ASPHALT CEMENT

(71) Applicant: PETRÓLEO BRASILEIRO S.A. - PETROBRAS, Rio de Janeiro (BR)

(72) Inventors: Luis Alberto HERRMANN DO NASCIMENTO, Rio de Janeiro (BR); Marcio DE FIGUEIREDO PORTILHO, Rio de Janeiro (BR); Margareth CARVALHO COUTINHO CRAVO, Rio de Janeiro (BR)

(21) Appl. No.: 18/529,811

(22) Filed: Dec. 5, 2023

(30) Foreign Application Priority Data
Dec. 6, 2022 (BR) 1020220248702

(51) Int. Cl. C08L 95/00; C08K 3/06

(52) U.S. Cl. CPC C08L 95/00; C08K 3/06; C08L 2207/22; C08L 2207/324; C08L 2312/00

(57) ABSTRACT

The present invention consists of the formulation of Petroleum Asphalt Cement (CAP) produced by the asphalt residue (RASF) or vacuum residue (RV) using Plastic Pyrolysis Oil (OPP) as an alternative diluent and may optionally consist of elemental sulfur as well as typically fossil diluents with reduced levels. The present invention further describes the process for obtaining said CAP composition.

### FIELD OF THE INVENTION

The present invention consists of the Petroleum Asphalt Cement (CAP—“Cimento Asfáltico de Petróleo”) composition produced by the typical refinery asphalt waste (RASF—“resíduo asfáltico”) route or vacuum residue (RV—“resíduo de vácuo”) using Plastic Pyrolysis Oil (OPP—“Óleo de Pirólise de Plástico”) as an alternative diluent as well as the process to obtain the aforementioned CAP. The new petroleum asphalt cement composition can optionally consist of elemental sulfur in order to increase the consistency of the CAP.

The use of OPP as an alternative diluent in the preparation of CAP has the advantage of increasing the added value of this product, as it reduces the product carbon footprint as well as facilitates the asphalt production. The present invention has application in CAP refineries.

### BACKGROUND OF THE INVENTION

Asphalt is a mixture of hydrocarbons derived from petroleum, which can be extracted from nature in asphalt rocks or through the oil refining process. They are commonly used in waterproofing services and together with aggregates for the production of asphalt mixtures.

According to Leite (LEITE, L. F. M. Estudos de preparo e caracterização de asfaltos modificados por polímeros. 1999. 266 f. Thesis (Doctorate). Federal University of Rio de Janeiro, Rio de Janeiro.), the Petroleum Asphalt Cement (hereinafter, CAP) is a semi-solid product at low temperature, viscoelastic at room temperature and liquid at high temperature. Therefore, it behaves as a fluid at temperatures close to 100° C. and as a pseudoplastic at temperatures between 25° C. and 60° C. Additionally, it should be noted that CAP, commonly used in asphalt mixtures, contributes negatively to the environment, in addition to being harmful to health as it releases significant amounts of toxic substances when heated (LEITE, F. L. M.; MOTTA, L. M. G.; CONSTANTINO, R. S.; TONIAL, I. A. Curso sobre o programa SHRP: Aplicação a ligantes, agregados e misturas betuminosas. Instituto Brasileiro de Petróleo. Rio de Janeiro, R J, 1996).

In the process for obtaining CAP, wherein it is a product from the bottom of the vacuum distillation tower, the adjustment of the consistency of the asphalt residue (RASF) typical of a refinery or the vacuum residue (RV) is often done with a compatible diluent to fit the product into the CAP ANP specifications (no. 19/2005) in force in Brazil. Currently, diluents for CAP come from 100% fossil refining, being among the main heavy gas oils (GOP) diluents, CAP gas oils specially cut to fit the CAP production (GOP CAP), recirculation gas oils (GOR—“gasóleos de recirculação”), decanted or clarified oils (ODEC—“óleos decantados ou clarificados”), bright stock aromatic extracts (EABS—“extratos aromáticos de bright stock”), heavy neutral aromatic extract (EANP—“extrato aromático de neutro pesado”), among others. Such diluents, when used in CAP, reduce loads from other units and often present restrictions or require adjustments to produce CAP, not to mention the increasingly reduced availability. For example, currently the diluent used to produce CAP at REDUC/PETROBRAS is EABS obtained during the production of lubricants. However, given the change in the unit's refining scheme, scheduled for 2026, where the production of this diluent will be carried out in the GASLUB industrial area, the Aromatic Extract will no longer be available at REDUC and will directly impact the delivery of asphalt products from the refinery, promoting relevant economic losses.

In this sense, it is worth highlighting that several studies seek to develop new diluents for RASF or RV, given the expected shortage of these streams in refining and the search for asphalt products with a lower carbon footprint, without compromising the performance. In this context, in addition to the development of diluents for the production of vegetable-based CAP, a Plastic Pyrolysis Oil (OPP) stream was studied, which, in addition of being promising for the production of CAP with good performance, is aligned with the Sustainability Commitment Corporate (ESG—Environmental, Social and Governance) of Petrobras.

Plastic Pyrolysis Oil (OPP) is produced through thermal processes that use unusable plastic packaging as feedstock, captured after disposal, giving circularity to carbon. Currently, unusable plastics end up in landfills or water beds. Its decomposition takes more than 400 years, contaminating nature and producing microplastics that are harmful to life. In mammals, for example, this material can lead to changes in metabolism and changes in the hormonal cascade (https://www.bbc.com/portuguese/geral-45555524; http://www.abes-mg.org.br/visualizacao-de-clipping/ler/4252/maioria-dos-plasticos-libera-compostos-parecidos-com-estrogenio; e https://doi.org/10.1590/S0100-40422007000300027). Therefore, the use of this environmental liability as a feedstock will immobilize the carbon originating from Urban Solid Waste (RSU—“Resíduos Sólidos Urbanos”) plastic in the form of CAP diluent, preserving environmental emissions and contamination, at the same time reducing refining restrictions for CAP production and increasing the added value of asphalt products sold.

Regarding the prior art, document U.S. Pat. No. 5,422,051 refers to plastic materials collected from discarded articles or manufacturing stock, reduced to particles, and mixed with feedstock for manufacturing building materials, such as concrete. A cementitious concrete made from recycled plastics, portland cement, and sand/gravel fillers performs to standards of concretes made without plastics. Heterogeneous plastic materials may be used in this concrete, removing the previously time and resource intensive step of sorting and melting down constituent plastics from each other in the waste stream. Although it uses recyclable plastic material to form concrete, the composition containing OPP, RASF or RV and sulfur of the present invention are not disclosed in this document. The process steps disclosed in this document are also completely different.

The document KR0185290 relates to a technique of using waste tire and waste oil pyrolysis residue as an asphalt concrete reinforcing material. However, it is worth noting that ground tire rubber is an asphalt modifier widely used by the asphalt industry. This waste is used in a wet or dry way, as a binder modifier or as an aggregate in asphalt concrete, respectively, always adding rubber particles directly to the asphalt (wet way) or to asphalt concrete (dry way). There is no pyrolysis in the rubber incorporation process, which is a very different route from that being proposed in this innovation.

Consequently, the use of this type as a RASF or RV diluent for the production of CAP, in addition to having the potential to meet the expected shortage of this type of stream, has the potential to reduce the CAP carbon footprint. Therefore, the objective of the invention to obtain CAP with circular carbon originating from OPP is achieved through the composition and process as disclosed herein.

### SUMMARY OF THE INVENTION

The present invention consists of the formulation of Petroleum Asphalt Cements using Plastic Pyrolysis Oil as a diluent as well as the process for obtaining said CAP. The optional use of elemental sulfur is also provided with the aim of fixing the light material originating from the OPP in the CAP and/or increasing its consistency.

### BRIEF DESCRIPTION OF THE FIGURES

The present invention will be described below, with reference to the attached FIGURE which, in a schematic way and not limited of the inventive scope, represents an example of its realization.

FIG. 1 illustrates the flowchart of the process for obtaining the new CAP composition.

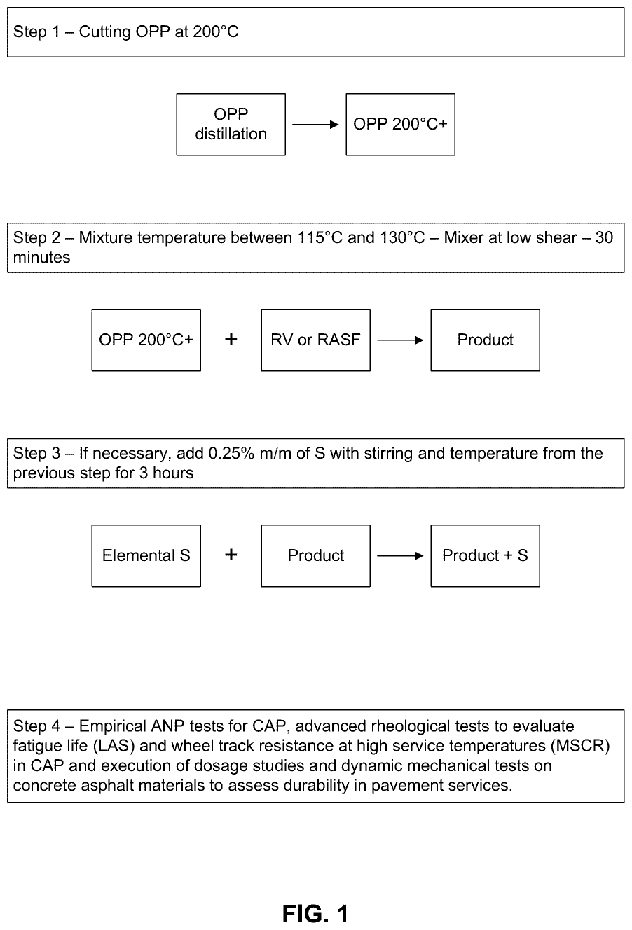

### DETAILED DESCRIPTION OF THE INVENTION

The present invention consists of the formulation of Petroleum Asphalt Cements (CAP) using Plastic Pyrolysis Oil (OPP) as an alternative diluent as well as its process for obtaining the CAP composition. It is worth noting that the OPP used in the present invention, obtained directly from the thermal conversion process (pyrolysis), is a diluent originating from processes external to the refinery, which impacts on a different configuration from that usually used in refining to produce CAP.

Furthermore, the inventive process for obtaining the CAP comprises the following steps:
cutting OPP at 200° C./200° C.⁺ during the distillation step;
   mixing the OPP diluent with RV or RASF in a mixer at low shear, at a temperature between 115° C. and 130° C., for 30 min resulting in the CAP; and
optionally, adding 0.25% by mass of sulfur to the mixture from the previous step stirring at 100 rpm and temperature between 115° C. and 130° ° C. for a period of 3 hours, this step being dependent on the consistency of the final product (CAP).

Additionally, a fourth step of advanced rheological tests is carried out to evaluate the fatigue life (LAS—Linear Amplitude Sweep) and resistance to wheel track at high service temperatures (MSCR—Multiple Stress Creep Recovery) in the CAP and carry out dosage studies and dynamic mechanical tests in asphalt cements to evaluate durability in service on pavement.

Regarding the first step of the process, it should be noted that to be applied as a diluent, the OPP can be cut into two bands: The first at 25° C.-200° C. (circular naphtha) and the bottom stream at 200° C.⁺ (CAP diluent), to remove the light fraction that does not comply with the CAP of the ANP specification (no. 19/2005), especially with regard to its mass variation parameters in the RTFOT test (Rolling Thin Film Oven Test). According to the aforementioned ANP specification (no. 19/2005), the diluent added to the RASF or RV cannot present light material that is released during the mass variation test by more than 0.5%, the RTFO test being essential for said measurement. This mass variation test is carried out using a Rolling Thin Film Oven (RTFO—Rolling Thin Film Oven) where a thin film of asphalt weighing 35 g is continuously rotated inside a glass container at 163° C. for 85 minutes, with an air injection every 3 to 4 seconds. The tubes are weighed before and after the oven and the mass variation cannot be greater than 0.5%. This test correlates with the hardening of the binder that occurs during the asphalt mixture machining and must be complied with as it is found in ANP Resolution (no. 19/2005) for Petroleum Asphalt Cements (CAP).

However, if said cut is not possible, the formulation of the present invention still contemplates the possible presence of a low content (0.25% by mass) of duly incorporated elemental sulfur (as illustrated in step 3 of the flowchart) or by means of prior cut of the light fractions to stabilize the OPP, with the aim of fixing the light material in the CAP and increasing its consistency. The addition of 0.25% by mass of said elemental sulfur occurs in the temperature range of 115° C. to 130° C. with stirring at 100 rpm. However, other ranges of cutting temperatures may be used to adapt the OPP in order to adjust the flash point to 60° C. according to the specification.

In the second step, the CAP composition must be obtained by adding the OPP (cut or not) to the RASF or RV. The OPP content will depend on the consistency of the RASF or RV+0.25% by mass of elemental sulfur (depending on the OPP cut). In this sense, it should be noted that the parameter for the OPP content in the formulation for CAP 30/45 and 50/70 will be the Brookfield viscosity value at 177° C. of the final mixture, which should not be less than 76 cP for CAP 30/45 and 57 cP for CAP 50/70, maintaining the respective product penetration ranges (30/45 or 50/70).

Furthermore, the formulation may have only OPP as a diluent or it may also have OPP together with another typical diluent (for example, aromatic extract, gas oil and decanted oil are refining streams also used as diluents for CAP). The incorporation of OPP into the RASF or RV must be carried out in a low shear mixing system, with the RASF or RV at a temperature between 115° C. and 130° C., and remain stirring at 10 rpm for 30 minutes.

In the third step, depending on the OPP cut, 0.25% by mass of elemental sulfur is added with constant stirring at 100 rpm and a temperature between 115° C. and 130° ° C. for 3 hours. The addition of elemental sulfur occurs for values in the mass variation test greater than 0.5% by mass and/or when the penetration ratio at 25° C./rotational viscosity at 177° C. needs to be adjusted to comply with the ANP specification (no. 19/2005).

After obtaining the final product, a fourth complementary step is carried out, where all the tests of the ANP specification (no. 19/2005) for petroleum asphalt cements and the dynamic shear rheological tests are carried out at a temperature of 64° C., MSCR at a temperature of 64° C. and LAS at a temperature of 19° C., in addition to mechanical tests on asphalt mixtures, in order to certify the suitability and performance of the CAP with OPP.

Through the steps of the new inventive process, it was possible to obtain the RASF or RV composition with the desired consistency, as well as it was possible to correct the consistency and fixation of the light components through the use of elemental sulfur in certain process conditions depending on the cut of the OPP.

The following embodiments of the present invention compositions have also been disclosed:

In this sense, the present inventive composition uses asphalt residue (RASF) typical of refinery or vacuum residue (RV), which in conventional circumstances would have to be diluted with the addition of 6% to 10% by mass with aromatic compounds, as an example, Bright Stock Aromatic Extracts (EABS), Heavy Neutral Aromatic Extract (EANP) or Decanted or Clarified Oils (ODEC) for CAP production. However, upon replacing the aromatic compounds with OPP the dilution was only required by 2.5% to 3.5% to adjust the CAP properties, proving the identification of a new viable diluent as described in this inventive composition.

Furthermore, some formulations included the addition of elemental sulfur, in a small amount (0.25% by mass), which, after the vulcanization process, fixed components in the CAP, adapting the consistency and stability of the final product.

The present invention provides for the use of small amounts of sulfur. In this sense, it should be noted that sulfur is one of the optional components of the invention used to correct or adjust the consistency of the final product, at the same time as it fixes volatile components that may be present in the OPP. When the OPP is heavier, however, sulfur fixation may be dispensed with from the process, depending on the mass loss of the product in the rolling rhin oven (RTFOT—Rolling Thin Film Oven Test). Therefore, the addition of small amounts of elemental sulfur, with due reaction time, helps to stabilize CAP with OPP.

The CAP compositions obtained by the present inventive process comply with the current Brazilian ANP specification (no. 19/2005) for CAP. For example, CAP composition containing RASF or RV, 2.75% by mass of OPP, 4.0% by mass of EABS and 0.25% by mass of sulfur was prepared with 100% specified properties, showing superior performance to the reference CAP both in terms of resistance to fatigue life (cracking) and permanent deformation (wheel track), showing to be extremely promising, as it reduces the use of 100% fossil diluents (EABS, for example) and produces CAP of good quality.

Furthermore, a formulation without another conventional diluent containing only RASF or RV, 2.75% by mass of OPP and 0.25% by mass of elemental sulfur was tested, that is, a formulation with full replacement of the typically fossil diluent.

It is worth highlighting that the performance of such CAPs with OPP was evaluated according to advanced rheological parameters, including wheel track resistance tests at high service temperatures (creep and recovery—MSCR) at elevated temperatures and fatigue life assessment (load amplitude sweep—LAS) at intermediate temperatures.

### EXAMPLE OF IMPLEMENTATION/TESTS/RESULTS

| CHARACTERISTICS | CAP 30/45 | FORMULATION |
|---|---|---|
| | REDUC | 2021-005954-05 |
| | TYPICAL VALUES | RASF REDUC + 2.75% |
| | CAP 30/45 | OPP + 0.25% Sulfur |
| ORIGINAL SAMPLE | | |
| Penetration (100 g, 5 s, 25° C.) | 31 | 25 |
| Brookfield Visc at 135° C. | 540.4 | 615.8 |
| Brookfield Visc at 150° C. | 257.2 | 276.3 |
| Brookfield Visc at 177° C., SP 21 | 88.1 | 96.2 |
| Dynamic shear 10 rad/s, T (° C.) | 70 | 70 |
| for G*/sinδ min. 1.0 kPa | 1.13 | 1.54 |
| Dynamic shear 10 rad/s at 64° C. | 2.6 | 3.51 |
| RTFOT at 163° C., 85 min | | |
| Mass variation | (+)0.0618 | (−)0.4636 |
| MSCR at 64° C. - Jnr3200; Jnrdif <0.75 | 1.2063 | 1.1433 |
| LAS - FFL - PSE | 1.278 | 1.36 |

ANP Technical Resolution no. 19 of 2005 determines all the criteria that must be met to specify the CAP for road application. This is a specification based on empirical data without considering information on the in-service behavior and durability of the asphalt material, therefore, some rheological performance tests, such as dynamic shear, MSCR and LAS were also considered. All these tests are carried out in the Dynamic Shear Rheometer (DSR—Dynamic Shear Rheometer).

The asphalt binder's tendency to permanent deformation can be monitored by the MSCR (Multiple Stress Creep and Recovery) test, which in a free translation that means Deformation and Recovery under Multiple Stresses. This analysis, carried out at 64° C., provides the Non-recoverable compliance parameter, symbolized by Jnr. The higher the Jnr value, the lower the binder's ability to recover from the deformations suffered by the shear action of traffic, in other words, the greater is its tendency to change definitively.

LAS (Linear Amplitude Sweep), Linear Deformation Amplitude Sweep, is an accelerated fatigue test in which failure of the asphalt binder leads to the occurrence of microfractures, inducing the formation of fatigue cracks. This test is generally used to evaluate the fatigue resistance of asphalt binder by applying cyclic loading at increasing amplitudes. Based on the damage characteristics of the material, the fatigue life of the asphalt binder can be calculated using predictive modeling techniques by calculating the FFL (Fator de Fadiga do Ligante—Binder Fatigue Factor) which the higher it is, the better is the resistance to fatigue cracking.

In the table above, you can compare the results of a typical REDUC CAP with formulations with 2.75% by mass of OPP. This increase was already expected for the mass variation test, as the diluent has a light front that is sensitized in this test. In this same table, it is noted that for the performance tests the formulations showed a relevant difference in the MSCR test, improving their resistance to permanent deformation and maintaining good performance in the Fatigue test (LAS).

The present invention innovates by using carbon from Urban Solid Waste (RSU) plastic in the form of a CAP diluent, preserving environmental emissions and contaminants and improving properties such as LAS and MSCR.

Therefore, the invention will allow petroleum asphalt cement (CAP) to be produced by the RASF or RV route using OPP as a diluent, thus eliminating or reducing the use of typical streams, minimizing restrictions for CAP production, while also reducing carbon emissions associated with the company's products.

1. Process for obtaining CAP characterized by comprising the following steps:
optionally, cutting the OPP at 200° C./200° C.⁺ during the distillation step;
mixing the OPP diluent with RV or RASF in a low shear mixer, at a temperature between 115° C. and 130° C., for 30 min; and
optionally, adding 0.25% by mass of elemental sulfur to the mixture from the previous step with constant stirring and a temperature between 115° C. and 130° C. for 3 hours; this step being dependent on the consistency of the final product (CAP).

2. Process, according to claim 1, characterized by further comprising a fourth step of carrying out empirical ANP tests (no. 19/2005) for CAP, rheological tests advanced to evaluate fatigue life (LAS) and resistance to wheel track at high service temperatures (MSCR) in the CAP and carrying out dosage studies and dynamic mechanical tests on asphalt cement to evaluate durability in service on the pavement.

3. Process, according to claim 1, characterized in that the addition of elemental sulfur from the third step is linked to the values in the higher mass variation test at 0.5% by mass and/or when the penetration ratio at 25° C./rotational viscosity at 177° C. needs to be adjusted to comply with the ANP specification (no. 19/2005).

4. Process, according to claim 3, characterized in that the Mass variation test is carried out using a Rolling Thin Film Oven (RTFO).

5. Process, according to claim 1, characterized in that the cutting temperature is preferably 200° ° C. and 200° C.+.

6. Petroleum asphalt cement composition obtained by the process as defined in claim 1, characterized by comprising asphalt residue (RASF) typical of refinery or vacuum residue (RV) and Plastic Pyrolysis Oil (OPP).

7. Composition, according to claim 5, characterized in that OPP is a diluent of said composition with mass dilution levels in CAP between 2.0% by mass and 3.5% by mass.

8. Composition, according to claim 5, characterized by being obtained through thermal processes that use waste plastic packaging collected after disposal as feedstock.

9. Composition, according to claim 5, characterized by optionally comprising a typically fossil diluent with a maximum content of 4.0% by mass.

10. Composition, according to claim 8, characterized in that the typically fossil diluent comprises heavy gas oils (GOP), CAP gas oils specially cut to fit the CAP production (GOP CAP), recirculation gas oils (GOR), decanted or clarified oils (ODEC), bright stock aromatic extracts (EABS), heavy neutral aromatic extract (EANP), among others.
